(19) United States
(12) Patent Application Publication
(10) Pub. No.: US 2015/0074699 A1
(43) Pub. Date: Mar. 12, 2015

(54) MULTIMEDIA DATA DISPLAY CONTROL ON AN AUDIO-VIDEO RENDERING DEVICE

(71) Applicant: Alcatel Lucent, Boulogne Billancourt (FR)

(72) Inventor: Marcel Mampaey, Brussels (BE)

(73) Assignee: ALCATEL LUCENT, Boulogne Billancourt (FR)

(21) Appl. No.: 14/388,662

(22) PCT Filed: Mar. 25, 2013
(86) PCT No.: PCT/EP2013/056186

§ 371 Date: Sep. 26, 2014

(30) Foreign Application Priority Data
Mar. 27, 2012 (EP) 12305352.2

(51) Int. Cl. H04N 21/458; H04N 21/442; H04N 21/81; H04N 21/435

(52) U.S. Cl. CPC H04N 21/458; H04N 21/435; H04N 21/44209; H04N 21/812
USPC 725/14

(57) ABSTRACT

A method to control, on an audio-video rendering device, e.g. a PC or a TV device (AVD), the display of a first amount of first multimedia data, e.g. a predetermined quota of advertisements, defined as a function of a second amount of second multimedia data, e.g. audio-video programs, already displayed on the rendering device. In case of advertisements, the first amount relates to the funding of the second amount of program already displayed on a first channel received on the rendering device. The purpose of the application of this method is then to collect sponsoring money from advertisers according to advertisements being played and reversely ensure retribution of the channels according to the timing of each program has been effectively watched. Owing to this method, the first amount of first multimedia data is displayed, or the funding of the watched program is achieved, even when the user of the TV device switches to a second channel before the program being fully watched and before the related first amount of advertisements being fully displayed on the first channel. To this end, when a user of the rendering device switches from the first channel to a second channel before the first amount of first multimedia data being fully displayed on the first channel, the method comprises the steps of determining the amount of first multimedia data already displayed on the first channel, calculating the missing amount of first multimedia data still to be displayed for achieving the display of this first

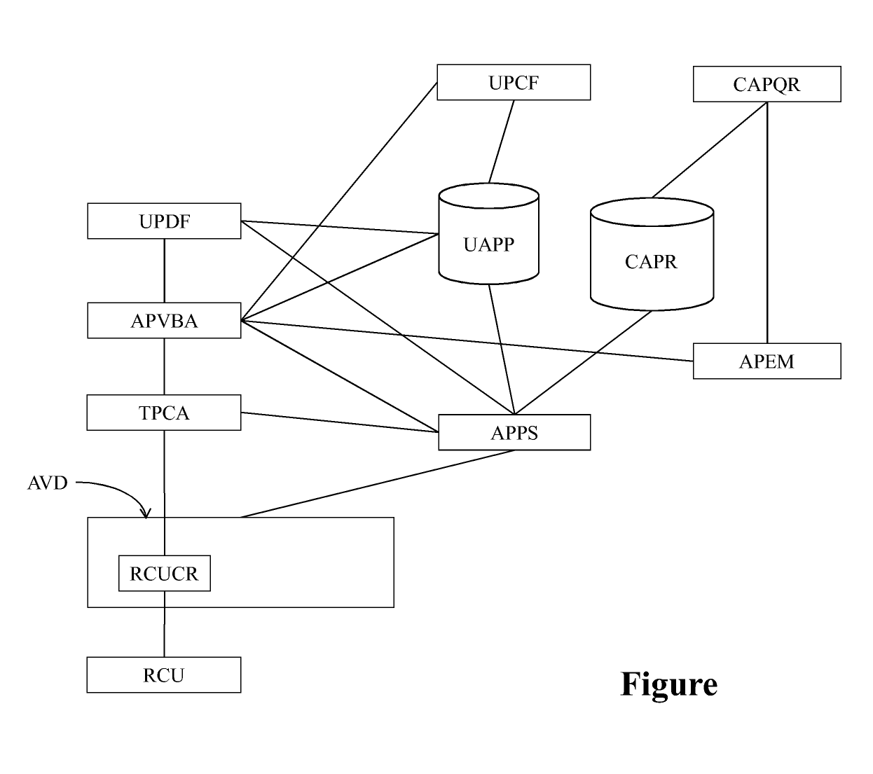

The present invention relates to a method to control, on an audio-video rendering device, the display of a first amount of first multimedia data, said first amount being defined as a function of a second amount of second multimedia data already displayed on a predetermined channel received on said audio-video rendering device.

In other words, when a second amount of second multimedia data is already displayed on the audio-video rendering device, a first amount of first multimedia data should also have been displayed on this audio-video rendering device. This first amount is a function of or in relation with, e.g. proportional to, the second amount and the purpose of the present method is to control that the second and the related first amount have been displayed on the audio-video rendering device.

The present method is particularly, but not exclusively, applicable to advertisements as first multimedia data, of which the first amount to be displayed is defined in function of the second amount of audio-video programs as second multimedia data that was already displayed on the audio-video rendering device. The advertisements are needed to fund the programs, and the type of first multimedia data, i.e. the type of advertisements, preferably relates to the type of second multimedia data, i.e. the type of audio-video programs.

The present method is similarly applicable to parental control for kids watching entertainment on TV as first multimedia data. In this case, the quota or amount of displayed first multimedia data is a function of or relates to an amount of watched educational programs as second multimedia data. As a consequence, in order to be able to watch entertainment programs (e.g. cartoons) as first multimedia data, the kids would have to watch a related amount of educational programs as second multimedia data.

Historically, the consumer market is not only migrating from the old analog TV broadcast to digital TV broadcast, digital cable TV and IPTV, but also more and more to TV “Over The Top” over the Internet.

In old analog TV or digital TV broadcast without time-shift or home recording, it is always possible for a user to change channel in order to avoid advertisements or “ads”, and this cannot be detected or prevented because there is no satisfactory technical solution to prevent advertisement skipping in analog TV.

In new digital solutions, there are often time-shift TV and/or home or networked digital video recorder functions available that make it even easier for users to avoid watching any programmed advertisement as they can fast forward through the advertisements.

In the context of time-shift TV, the time shift function is perceived as an (almost) unconstrained time-gliding function, such that it comes as unnatural to disable the fast forward button when there are advertisements.

Similarly, when users view content from the home digital video recorder, the device is perceived as similar to old analog VHS video recorders (also called VCR) such that the fast forward button is perceived as providing complete liberty to skip the entirety of the programmed advertisements.

At the moment, in analog or digital TV broadcast without time-shift or recording there is no technical solution to prevent the user from switching channels to avoid watching advertisements.

The only workaround used by advertisement providers to enforce advertisements on users is to try program their advertisements approximately at the same time on different channels such that users switching channels to avoid watching advertisements are still forced to watch advertisements on other channels. However this does not work very well when programs have different lengths, also, the currently viewed channel loses its users and thereby potential advertisement revenue (although this loss can only be measured statistically).

This solution also compromises the existing competition rules between channels where channels compete between each other based on their content programming instead of based on advertisement playtime and this inter-channel competition is also based on program scheduling.

Similarly, in the case of digital broadcast with time-shift feature or home digital video recorder, there is no satisfactory technical solution to force the user to view the advertisements as both time-shift feature or home digital video recorder provide a fast forward function that allows the user to skip any part of the program easily, including advertisements, such that it would be difficult to disable the fast forward button during advertisement play.

As a consequence, less and less advertisements are being viewed by users in Over The Top solutions or digital TV solutions.

Advertisement enforcement is difficult, even in digital TV experiences, although advertisements are needed to fund programs.

In other words, a predetermined quota of advertisements has to be played on each predetermined channel to guarantee the funding of a program played on that channel, the advertisements being preferably related to the program.

In the context of advertizing in digital TV, IPTV, and Over The Top TV and Video, users may be able to change channels or user trick play commands to skip advertisements and avoid watching advertisements. In this context each predetermined channel loses its ability to control advertisement viewing by the users.

As a consequence, the predetermined channel is no longer able to guarantee program funding by sufficient related advertisement-play as it has lost control over this feature.

Methods can help to guarantee advertisements are being watched, e.g. the United States Patent Application US 2002/0191950 A1 entitled “Apparatus and a method for preventing commercial skipping” of WANG Xiaoling and published on Dec. 19, 2002. Therein is disclosed a system, apparatus, and method that can enable or disable all manual and automated skipping functions of a video recording and playback device based on a content classification signal which is associated with a video signal. The content classification signal may be comprised of a plurality of portions each of which indicating whether commercial or non-commercial content is in a particular portion of a video signal. The manual and automated skipping functions may include all functions that allow fast forward with and without video content display, fast forward with different speeds, fast forward with varying speed, one-button skipping functions with at least one preset skipping time or length interval, and smart skipping functions that skip only to a certain end point set automatically or manually. The system and the method according to this known Patent Application offers also flexible possibilities to selectively disable or enable the skipping functions based on a set of management parameters such as television channel identification, television program identification, television program class identification, date and time identification, as well as subscription related information. In addition, the system and the method according to the known Patent Application provides a user-definable content classification signal in a content description file which is associated with the video signal to form the video plus content classification signal.

This can be seen as a method for controlling the display of advertisements by a user of an audio-video rendering device. The advertisements have to be played on the device during a predetermined advertisement time window or playtime. The advertisements are over-provided so that the play duration of all the advertisements exceeds the advertisement playtime. The user is then allowed to skip an advertisement towards a next advertisement thereby adding a certain degree of freedom resulting in a lower frustration.

An object of the present invention is to provide a method to guarantee that, when a second amount of second multimedia data has been displayed on the audio-video rendering device, a related first amount of first multimedia data should also be displayed on this audio-video rendering device anyway. This means, in case of advertisements as first multimedia data, that the quota of advertisements watched by the user should be sufficient for funding the amount of related displayed program, i.e. the second multimedia data.

According to a characterizing embodiment of the invention, this object is achieved due to the fact that, when a user of said audio-video rendering device switches from the display of said predetermined channel to the display of a second channel received on said audio-video rendering device before said first amount of first multimedia data being fully displayed on said predetermined channel, said method comprises the steps of

determining the displayed amount of first multimedia data already displayed on said predetermined channel,

calculating the missing amount of first multimedia data still to be displayed for achieving the display of said first amount of first multimedia data, and

controlling the display of said missing amount of first multimedia data on said second channel received on said audio-video rendering device.

In this way, the first amount of first multimedia data, e.g. the quota of advertisements, displayed in total on the audio-video rendering device, i.e. even if the user switches to a second channel, corresponds to the second amount of second multimedia data, e.g. the amount of program watched on this device and more particularly to the required funding of the played program. In other words, the first multimedia data display control, or advertisement-play control, for the second multimedia data, or played program, is handled in a global fashion across channels.

It is to be noted that said audio-video rendering device may be a TV, a PC, a Tablet, a NetBook, a Smartphone, a “Set Top Box” or any other audio-video rendering capable device.

In a preferred characterizing embodiment of the present invention, said missing amount of first multimedia data is equal to the difference between said first amount of first multimedia data and said displayed amount of first multimedia data.

This guarantees advertisement-play program funding and channel retribution according to advertisements effectively played and according to programs effectively watched.

In another preferred characterizing embodiment of the present invention, said first type of said first multimedia data is associated to a profile of the user of said audio-video rendering device.

Still another characterizing embodiment of the present invention is that said missing amount of first multimedia data may be prevented to be displayed on said second channel according to said first type of said first multimedia data.

Each channel can specify incompatibilities between the type of the first multimedia data and that of the multimedia data displayed on the second channel, or between certain advertisements and programs. Owing to this feature, particular types of first multimedia data, e.g. offensive advertisements, may not being displayed in programming then displayed on the second channel and destined to more sensitive people.

Again another characterizing embodiment of the present invention is that missing amount of first multimedia data prevented to be displayed on said second channel is displayed on a third channel received on said audio-video rendering device when the user of said audio-video rendering device switches to the display of said third channel.

In this way, the missing related advertisements will be displayed anyway. In this case, on a third channel rather than on the second channel.

Yet another characterizing embodiment of the present invention is that each first type of said first multimedia data has a predetermined weight, and said first amount is affected by the predetermined weights of said first multimedia data.

In this way, the duration of the playtime of the related advertisements, and more particularly of the missing related advertisements, may be different in function of the weights or quota values associated to each of the advertisements.

Further characterizing embodiments of the present method are mentioned in the appended claims.

It is to be noticed that the terms “comprising” or “including”, used in the claims, should not be interpreted as being restricted to the means listed thereafter. Thus, the scope of an expression such as “a device comprising means A and B” should not be limited to an embodiment of a device consisting only of the means A and B. It means that, with respect to embodiments of the present invention, A and B are essential means of the device.

Similarly, it is to be noticed that the term “coupled”, also used in the claims, should not be interpreted as being restricted to direct connections only. Thus, the scope of the expression such as “a device A coupled to a device B” should not be limited to embodiments of a device wherein an output of device A is directly connected to an input of device B. It means that there may exist a path between an output of A and an input of B, which path may include other devices or means.

The above and other objects and features of the invention will become more apparent and the invention itself will be best understood by referring to the following description of an embodiment taken in conjunction with the accompanying drawings wherein the FIGURE shows various steps of the present method.

The method of the present invention controls, on an audio-video or Video PlayBack rendering device AVD, the display of first multimedia data, which in this example are preferably but not exclusively advertisements. The amount of displayed first multimedia data is controlled with respect to an amount of second multimedia data, preferably audio-video programs, which were already displayed on a channel received on the rendering device.

It is to be noted that the present method similarly applies to parental control for kids watching entertainment on TV. In this case, the quota or amount of displayed first multimedia data relates to educational programs. So in order to be able to watch entertainment programs (e.g. cartoons), the kids would have to watch a related amount of educational programs as second multimedia data.

Playing advertisements as a first type of first multimedia data on the audio-video or Video PlayBack Rendering Device AVD, which may be a TV device, a PC, a Tablet, a NetBook, a Smartphone, a “Set Top Box” or any other audio-video rendering capable device is needed to fund the programs as a second type of second multimedia data. In other words, in case of advertisements the purpose is to collect sponsoring money from advertisers according to advertisements being played and reversely ensure retribution of each predetermined channel according to the timing of each program effectively watched from each predetermined channel.

It is to be noted that the word “channel” must be understood in the broad sense as a set of programs provided by a Service Provider SP such as, e.g., a TV Broadcaster (commonly called a “TV Channel”) or an “Over The Top” OTT Service Provider over the Internet. The Service Provider SP may provision the programs to the user in the form of continuous programs in real-time or in time-shift provisioning or with on-demand provisioning, via Cable or DSL or other means. In case of TV Broadcaster, the programs are transmitted by means of infrastructures such as Digital TV or IPTV or the Internet, whilst in case of OTT Service Provider, the programs are transmitted over the Internet.

The description below will more specifically relate to a TV device AVD as audio-video rendering device although the explanations are applicable to any other kind of audio-video rendering capable device. The TV device AVD is provided with a Remote Control Unit Command Receiver RCUCR receiving control signals from a Remote Control Unit RCU and coupled to a Trick Play Command Analyzer TPCA ultimately receiving trick play commands, generally from the control unit RCU, and responsible to react to such trick play commands.

To each program displayed on a predetermined channel received on the TV device AVD corresponds a predetermined quota or amount of advertisements related to the funding of that program. Generally, the display of the program is interrupted for at least one predetermined time moment for displaying the related advertisements, so that the predetermined quota or amount of advertisements is displayed when the program ends.

However, when the user of the TV device switches to another channel while the program is not yet fully watched, the amount of advertisement corresponding to the already displayed program may not be fully displayed. The watched part of the program is then not completely funded.

The basic idea of the present method is to relate the advertisement-play control to each individual user and to handle advertisement-play in a global fashion across channels, based on an advertisement-play amount method.

In this method each predetermined channel indicates the required amount of advertisement-play for each of its programs and can also specify the type of advertisements that is expected or allowed to be played within or adjacent to each of its individual programs.

The required amounts or quotas are provided by a Channels Ad-Play Quotas Requirements function CAPQR controlling a Channel Ad-Play Requirements database CAPR containing the advertisements to be displayed, the advertisements being provided thereto by one or more advertisement servers.

It is to be noted that the different functional modules depicted in the FIGURE do not enforce a specific implementation such that several functional modules could be grouped in one or certain functional modules could be split in sub-modules. Also the functional modules may be deployed in a network, the ISP domain, the cloud, in customer premises infrastructures, and may be deployed at more than one place.

In order to match the part of program or second multimedia data effectively watched by the user with the quota, generally a time duration, of viewed advertisement or first multimedia data related to that program, the present method comprises:

determining the amount of first multimedia data or advertisement already displayed on the first or predetermined channel,

calculating the missing amount of advertisement still to be displayed for completing the funding of the already watched amount of program or the already displayed second multimedia data, when the user switches to a second channel, and

controlling the display of the missing amount of advertisement on the second channel.

The amount of program already watched is determined by an Ad-viewing and Programs Viewing Behavior Analyzer APVBA coupled to the Trick Play Command Analyzer TPCA from which APVBA receives information.

With this information, an Ad-Play Effectiveness Measurer APEM, coupled to the Ad-viewing and Programs Viewing Behavior Analyzer APVBA, can determine a second amount of required related advertisements as well as a third amount of already displayed related advertisements. The second amount of required related advertisements corresponds to the funding of the already watched amount of program. The missing amount of missing related advertisements at the moment that the user changes of channel is equal to the difference between the second and third amounts. The information concerning the missing related advertisements is transmitted for control from the Ad-Play Effectiveness Measurer APEM to the Ad-viewing and Programs Viewing Behavior Analyzer APVBA.

Finally, the missing related advertisements are displayed on the second channel to which the user has switched.

It is to be noted that the advertisements stored in the Channel Ad-Play Requirements database CAPR are selected and transmitted to the TV device AVD by means of an Advertisement-Play Programmer and Scheduler function APPS controlled by the Ad-viewing and Programs Viewing Behavior Analyzer APVBA and the Trick Play Command Analyzer TPCA.

In a preferred embodiment, each related advertisement, and thus also each of the missing related advertisements, has a distinct predetermined type. Consequently, some missing related advertisements may be prevented to be displayed on the second channel because of their predetermined type.

Indeed, each predetermined channel indicates, by means of the Channels Ad-Play Quotas Requirements function CAPQR, the required amount of advertisement-play for each of its programs and can also specify the type of advertisements that is expected or allowed to be played within each of its individual programs. However, each (second) channel can also specify incompatibilities between certain advertisements and programs such that offensive advertisements are not played in programming destined to more sensitive people.

The missing related advertisements prevented to be displayed on the second channel may then be displayed on a third channel received on the TV device AVD when the user switches from the second to the third channel. In some cases, this third channel may be the first predetermined channel received on the TV device AVD.

It is to be noted that channels may provide advertisements about their own programs, such as TV programs advertisements, and feed them in the advertisement servers in order to be displayed on other channels. In this case, the predetermined quota or amount of related advertisements may comprise advertisements related to programs provided on at least one other channel different from the first predetermined channel. These advertisements may possibly play across channels as well. This can be convenient for advertising certain programs of a certain channel within similar programs on other channels.

In an embodiment of the present method, the type of related advertisement may also be associated to a profile of the user, or to profiles of several users.

In this case, a User Presence Detection Function UPDF, coupled to the Ad-viewing and Programs Viewing Behavior Analyzer APVBA, detects and identifies which user(s) is currently watching the TV device AVD. A further User Profile Composition Function UPCF, controlled by the Ad-viewing and Programs Viewing Behavior Analyzer APVBA, consists in building a user profile according to, e.g., his/her behavior on the trick play commands.

All the user profiles are stored in a User Ad-Play Profiles database UAPP that is coupled to the Ad-viewing and Programs Viewing Behavior Analyzer APVBA, the User Profile Composition Function UPCF and the User Presence Detection Function UPDF.

The Advertisement-Play Programmer and Scheduler function APPS is then also controlled by the User Presence Detection Function UPDF in its selection and transmission of advertisements to the TV device AVD.

In this embodiment, the advertisements profiles and requirements come from both the user profile and the TV channels advertisements requirements and are combined into a single advertisement-programming towards a certain user. This combination provides an optimized advertisement-play and advertisement relevance within a certain program and towards a certain user.

The user-related advertisement-play control method thus handles all advertisements across channels globally towards an individual user in order to guarantee program funding and advertisement-play in spite of the user's changing behavior and TV viewing habits.

The above predetermined quota of related advertisements represents a predetermined amount of related advertisements and is generally measured as a duration of time during which the related advertisements have to be displayed for funding the associated program.

However, in a preferred embodiment, each related advertisement of the predetermined amount may have a distinct quota value or weight. The sum of the quota values of the related advertisements is then equal to the predetermined quota or amount to achieve. In this case, the duration of the playtime of the related advertisements, and more particularly of the missing related advertisements, may be different in function of the quota values or weights associated to each of these advertisements.

It is finally to be noted that these advertisement-play guarantees may further allow reducing the required advertisement playtime as advertisement-effectiveness can be easily measured, ensured and thus controlled.

Summarizing, the present method consists in collecting all required quotas of advertisement-play for each individual program of all the available channels. Therefore, the system accumulates quotas requirements from all the programs or parts of programs that are being viewed by a certain user, and ensure that the corresponding amount of advertisements is being played in order to guarantee advertisement-play funding of all programs across channels. This is needed in particular because in current digital TV viewing experience it is needed to relate the advertisement-play control to each individual user and to handle advertisement-play in a global fashion across channels.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. A method to control, on an audio-video rendering device (AVO), the display of a first amount of first multimedia data, said first amount being defined as a function of a second amount of second multimedia data already displayed on a predetermined channel received on said audio-video rendering device,
wherein, when a user of said audio-video rendering device (AVO} switches from the display of said predetermined channel to the display of a second channel received on said audio-video rendering device before said first amount of first multimedia data being fully displayed on said predetermined channel, said method comprises:
determining the displayed amount of first multimedia data already displayed on said predetermined channel,
calculating the missing amount of first multimedia data still to be displayed for achieving the display of said first amount of first multimedia data, and
controlling the display of said missing amount of first multimedia data on said second channel received on said audio-video rendering device.

2. The method according to claim 1, wherein said missing amount of first multimedia data is equal to the difference between said first amount of first multimedia data and said displayed amount of first multimedia data.

3. The method according to claim 1, wherein said first multimedia data is of a first type, said second multimedia data is of a second type, and said first type relates to said second type.

4. The method according to claim 3, wherein said first type of said first multimedia data is associated to a profile of the user of said audio-video rendering device (AVO).

5. The method according to claim 1, wherein said missing amount of first multimedia data may be prevented to be displayed on said second channel according to said first type of said first multimedia data.

6. The method according to claim 5, wherein missing amount of first multimedia data prevented to be displayed on said second channel is displayed on a third channel received on said audio-video rendering device (AVO) when the user of said audio-video rendering device switches to the display of said third channel.

7. The method according to claim 6, wherein said third channel is said predetermined channel received on said audio-video rendering device (AVO).

8. The method according to claim 3,
wherein each first type of said first multimedia data has a predetermined weight,
and in that said first amount is affected by the predetermined weights of said first multimedia data.

9. The method according to claim 1, wherein said first multimedia data are provided by at least one first multimedia data server.

10. The method according to claim 1,
wherein the display of said second multimedia data is interrupted for at least one predetermined time moment for displaying first multimedia data,
and in that the display of said second channel is interrupted for at least another predetermined time moment for displaying first multimedia data.

11. The method according to claim 2, wherein said first type of said first multimedia data relates to a third type of third multimedia data provided on at least one other channel adapted to be received on said audio-video rendering device (AVO), said other channel being different from said predetermined channel and from said second channel.

12. The method according to claim 1, wherein said audio-video rendering device (AVD) is a TV, a PC, a Tablet, a NetBook, a Smartphone, a “Set Top Box” or any other audio-video rendering capable device.
